(19) United States
(12) Patent Application Publication
(10) Pub. No.: US 2013/0115564 A1
(43) Pub. Date: May 9, 2013

(54) FUEL NOZZLE TIP INCORPORATING COOLING BY IMPELLER FINS

(71) Applicants: Satish Akkur Marigowda, Bangalore (IN); Karthick Kaleeswaran, Bangalore (IN); Venugopal Polisetty, Bangalore (IN); Ajay Kumar Verma, Bangalore (IN)

(72) Inventors: Satish Akkur Marigowda, Bangalore (IN); Karthick Kaleeswaran, Bangalore (IN); Venugopal Polisetty, Bangalore (IN); Ajay Kumar Verma, Bangalore (IN)

(73) Assignee: GENERAL ELECTRIC COMPANY, Schenectady, NY (US)

(21) Appl. No.: 13/289,499

(22) Filed: Nov. 4, 2011

(51) Int. Cl. F23D 14/00; B05B 1/00

(52) U.S. Cl. 431/159; 222/566

(57) ABSTRACT

A combustion burner and a nozzle tip to a combustion burner is disclosed. The nozzle tip includes a face and at least one passage at the face enabling a gas impinging on the face to flow through the nozzle tip. At least one rib extends from the face to transfer heat from the nozzle tip to the impinging gas. The at least one rib extending from the face of the nozzle tip provides a surface area of the face that is greater than the surface area of a planar face. The nozzle tip can be coupled to an end of a nozzle of the combustion burner. The gas can be an air and/or an air/fuel mixture.

### BACKGROUND OF THE INVENTION

The subject matter disclosed herein relates to nozzle tips and in particular to features of the nozzle tip that enable cooling of the nozzle tip. Fuel nozzles can provide an air/fuel mixture that is configured for combustion once the mixture escapes from the nozzle. Nozzle tips are designed to provide an airflow for a combustion flame. Due to its proximity to the flame, nozzle tips generally experience elevated temperatures and thermal stress. As a result, nozzle tips experience issues having to do with tip burning and oxidation, which can lead to degradation of the nozzle tips. The present disclosure provides a nozzle tip having a nozzle tip that enables cooling of the nozzle tip.

### BRIEF DESCRIPTION OF THE INVENTION

According to one aspect, the present disclosure provides a nozzle tip that includes a face, at least one passage at the face configured to enable a gas impinging on the face to flow through the nozzle tip; and at least one rib extending from the face configured to transfer heat from the nozzle tip to the impinging gas.

In another aspect, the present disclosure provides a combustion burner, including a nozzle for dispensing a gas for combustion; and a nozzle tip coupled to an end of the nozzle, wherein the nozzle tip includes a face configured to be directed toward the nozzle when the nozzle tip is coupled to the nozzle, at least one passage at the face configured to enable the gas from the nozzle to flow through the nozzle tip, and at least one rib extending from the face configured to transfer heat from the nozzle tip to the gas.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 shows an exemplary nozzle suitable for use with the nozzle tip of the present disclosure;

FIG. 2 shows an exemplary nozzle tip according to the present disclosure having features for cooling the nozzle tip from a temperature of a combustion flame at the nozzle tip;

FIG. 3 shows an alternate embodiment of an exemplary nozzle tip of the present disclosure;

FIG. 4 shows an alternate embodiment of a nozzle tip including ribs in the form of spiral arms formed on interior face;

FIG. 5 shows an alternate embodiment of nozzle tip including ribs in the form of spiral arms formed on interior face;

FIG. 6 shows exemplary air/fuel mixture passages formed at an interior face of an exemplary nozzle tip;

FIG. 7A-C shows temperature profiles obtained at an exterior face of various nozzle tips described herein;

FIG. 8A-C shows stress profiles obtained for various nozzle tips described herein.

The detailed description explains embodiments of the disclosure, together with advantages and features, by way of example with reference to the drawings.

### DETAILED DESCRIPTION OF THE INVENTION

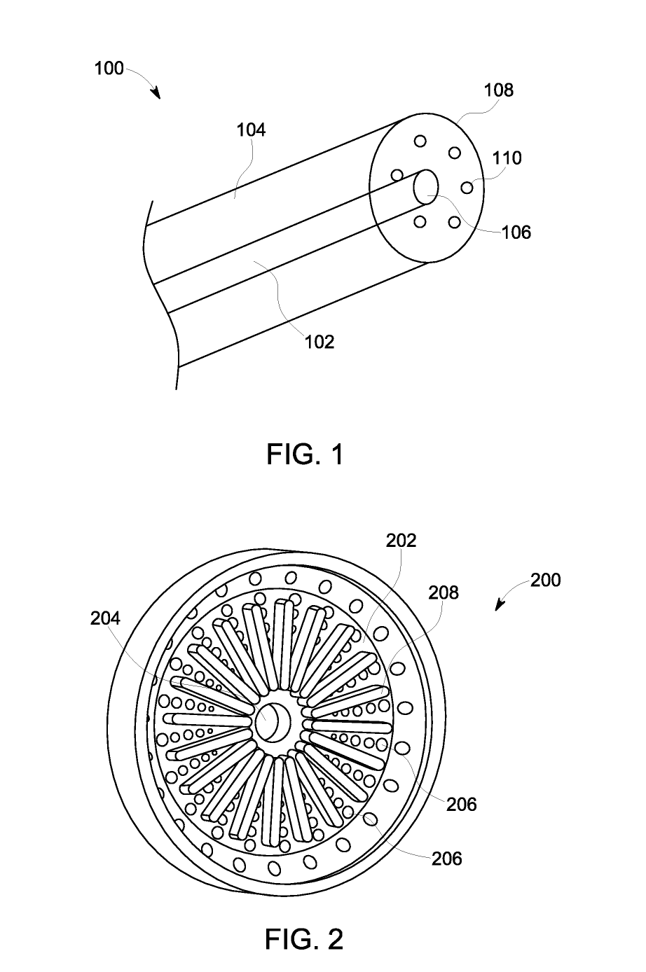

FIG. 1 shows an exemplary nozzle 100 suitable for use with a nozzle tip of the present disclosure. The exemplary nozzle 100 includes an air conduit 102 for the flow of air and an air/fuel conduit 104 for flow of an air/fuel mixture. In generally, the air and air/fuel mixture flow through conduits 102 and 104 toward the nozzle tip. Exemplary nozzle tip 108, which can be one of the exemplary nozzle tips disclosed herein, is fitted at an end of the nozzle 100. Exemplary nozzle tip 108 includes an air passage 106 that allows air to flowing in the air conduit 102 to escape to an exterior region of the nozzle and air/fuel passages 108 that allow the air/fuel mixture flowing in the air/fuel conduit 104 to escape to the exterior region of the nozzle. In various uses, escaping gases combust at the exterior region. The combustion or flame provides heat and thermal stress to the nozzle tip, generally leading to a degradation of prior art nozzle tips.

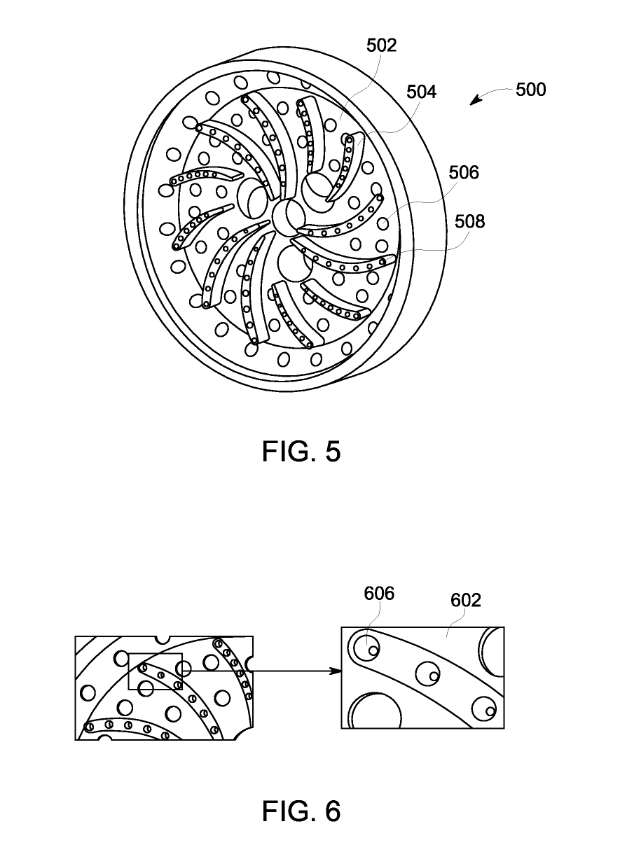

FIG. 2 shows an exemplary nozzle tip 200 according to the present disclosure having features for cooling the nozzle tip from a temperature of a combustion flame at the nozzle tip. The exemplary nozzle tip is circular in axial cross-section, although any axial cross-section suitable for fitting on a nozzle is considered herein. The exemplary nozzle tip includes an interior face 202 which is directed toward an interior of the nozzle when the nozzle tip is disposed on the nozzle and an exterior face (not shown) opposite the interior face on the nozzle tip. Nozzle tip 200 further includes an air passage 204 allowing air to pass through the nozzle tip and one or more air/fuel passages 206 allowing an air/fuel mixture to pass through the nozzle tip. In various aspects, interior face 202 includes features that provide a surface area to interior face 202 that is greater than surface area of a planar face of equal axial cross-section. In general, the features on interior face 202 facilitate cooling of the nozzle tip by increasing the surface area and consequently, the amount of contact between the nozzle tip and the air or air/fuel mixture. In an exemplary embodiment, interior face 202 includes one or more ribs 208 extending from the face. A typical rib includes a raised portion of the interior face. In the exemplary nozzle tip 200, at least one rib is aligned along a radial line of the interior face 202. Alternately, a rib 208 can be formed along a spiral emanating from a substantial center of the nozzle tip, as shown in FIGS. 4-5. A rib can be of uniform width. Alternately, the width of a rib can vary depending on location. For example, a rib can be tapered with decreasing radial distance from the center so that the width of a portion of the rib is proportional to the distance the portion is from the center of the interior face 202. A height at which a rib extends above interior face 202 can be uniform. Alternately, the height of a rib can depend on the location of the rib section. In one embodiment, a radially central end of the rib extends above the face to a height that is less than or equal to a height that a radially distal end of the rib extends above the face. Varying the height of the rib in this manner generally increases a surface area of a face of the rib that receives impinging gas, thereby promoting greater heat transfer between nozzle and gas and cooling of the nozzle tip.

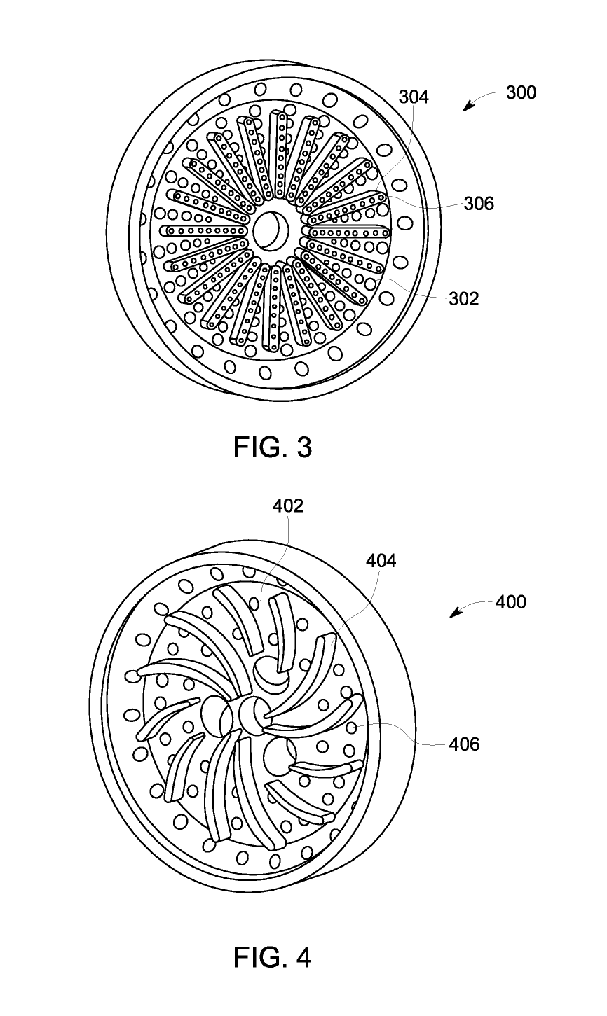

FIG. 3 shows an alternate embodiment of an exemplary nozzle tip 300 of the present disclosure. The nozzle tip 300 includes one or more ribs 304 extending from the interior face 302. Each rib 304 includes one or more air passages 306 for providing airflow through the nozzle tip. The ribs can be formed along a radial line of the face of the nozzle tip. Each rib can be of uniform width at each radial location. Alternatively, the width of the rib can vary with a location, such as a rib width that tapers with decreasing radial distance from the center of the interior face 302. The height of the rib above interior face 302 can be uniform or can vary depending on the location of the rib section. In one embodiment, a radially central end of the rib extends above the face to a height that is less than or equal to a height that a radially distal end of the rib extends above the face.

FIG. 4 shows an alternate embodiment of a nozzle tip 400 including ribs 404 in the form of spiral arms formed on interior face 402. In various embodiments, rib 404 can be tapered to decrease in width with decreasing radius, as discussed with respect to the nozzle tip of FIG. 2. The height of rib 404 can be uniform or can be varied, such as by increasing the height of the rib with increasing radial distance from the center, as discussed with respect to the nozzle tip of FIG. 2. Nozzle tip 400 includes air/fuel passages 406 in the interior face 402 at various locations between the ribs 404.

FIG. 5 shows an alternate embodiment of nozzle tip 500 including ribs 504 in the form of spiral arms formed on interior face 502. In various embodiments, the width of the rib 504 can depend on location on the interior face 502. For example, rib 504 can be tapered to decrease in width with decreasing radius, as discussed with respect to the nozzle tip of FIG. 2. The height of rib 504 can be uniform or can be varied such as by increasing the height of the rib with increasing radial distance from the center, as discussed with respect to the nozzle tip of FIG. 2. Interior face 502 includes various air-fuel passages 506 at various locations between the ribs 504. The ribs can also include various air passages 508.

FIG. 6 shows exemplary air/fuel mixture passages 606 formed at an interior face 602 of an exemplary nozzle tip, such as the exemplary nozzle tips of FIGS. 2-5. The cross-sectional area of the passage 606 can vary with depth. An exemplary passage 606 can have a cross-sectional area that decreases with increasing depth into the nozzle tip, wherein depth is measured from interior face 602. For example, the passage 606 can be conical in shape. Alternatively, the cross-section area of a passage can be uniform with depth, such as a cylindrical passage.

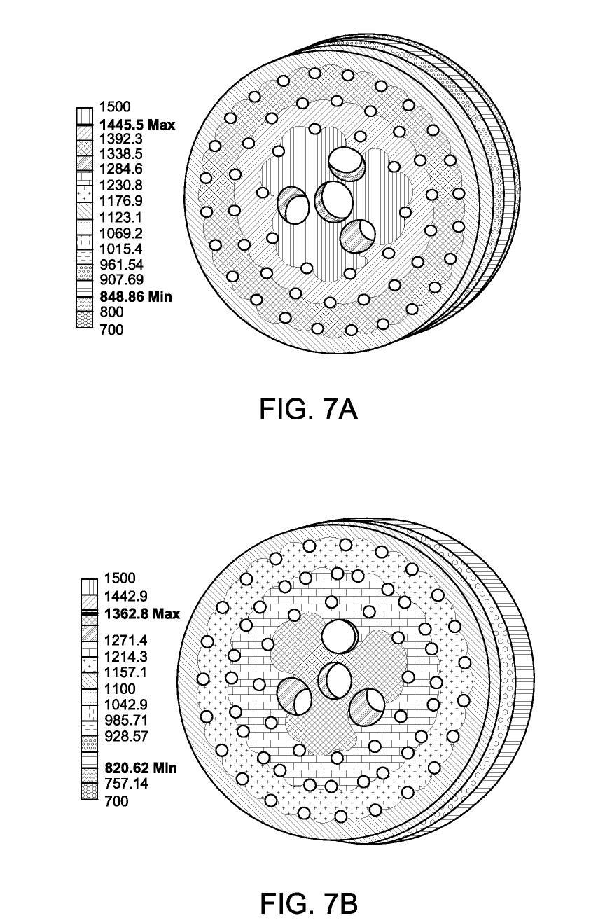

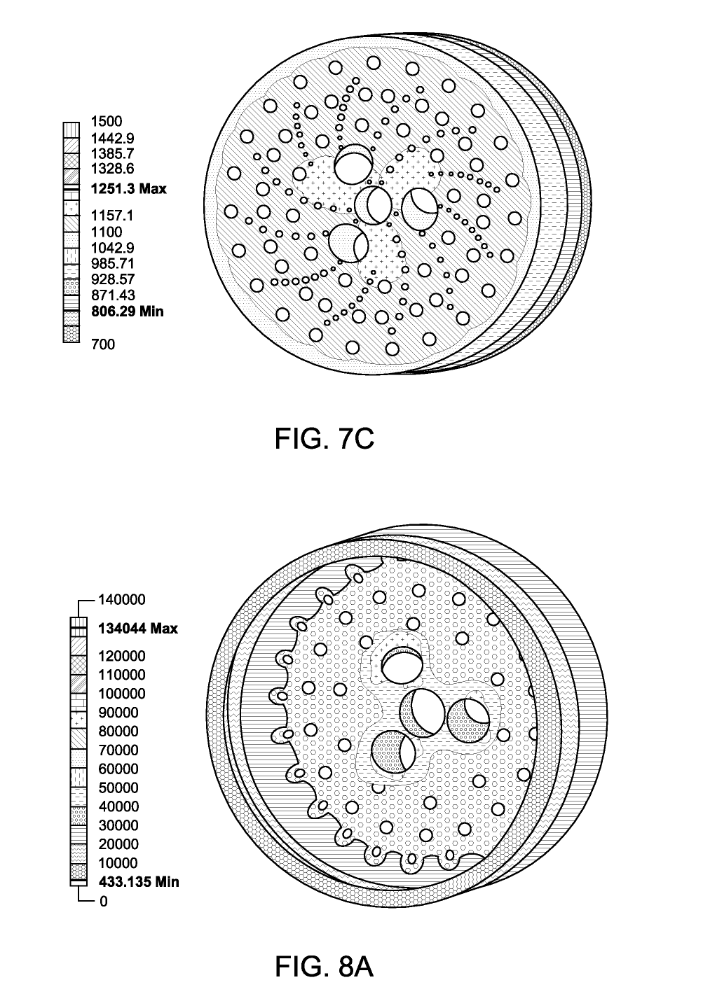

FIGS. 7A-C shows temperature profiles obtained at an exterior face of various nozzle tips described herein. FIG. 7A shows an exemplary prior art nozzle tip having a planar interior face (i.e., no ribs or features on interior face). A maximum temperature of 1446° F. occurs at the center of the nozzle tip. FIG. 7B shows a temperature profile of an exemplary nozzle tip 400 of FIG. 4 having spiral ribs. A maximum temperature of 1362° F. is at the center of the nozzle tip. FIG. 7C shows a temperature profile of exemplary nozzle tip 500 of FIG. 5 having spiral ribs and having air passages on the spiral ribs. A maximum temperature of 1251° F. is at the center of the nozzle tip. The temperature profiles of FIGS. 7A-C therefore show the cooling effect of the features disclosed herein.

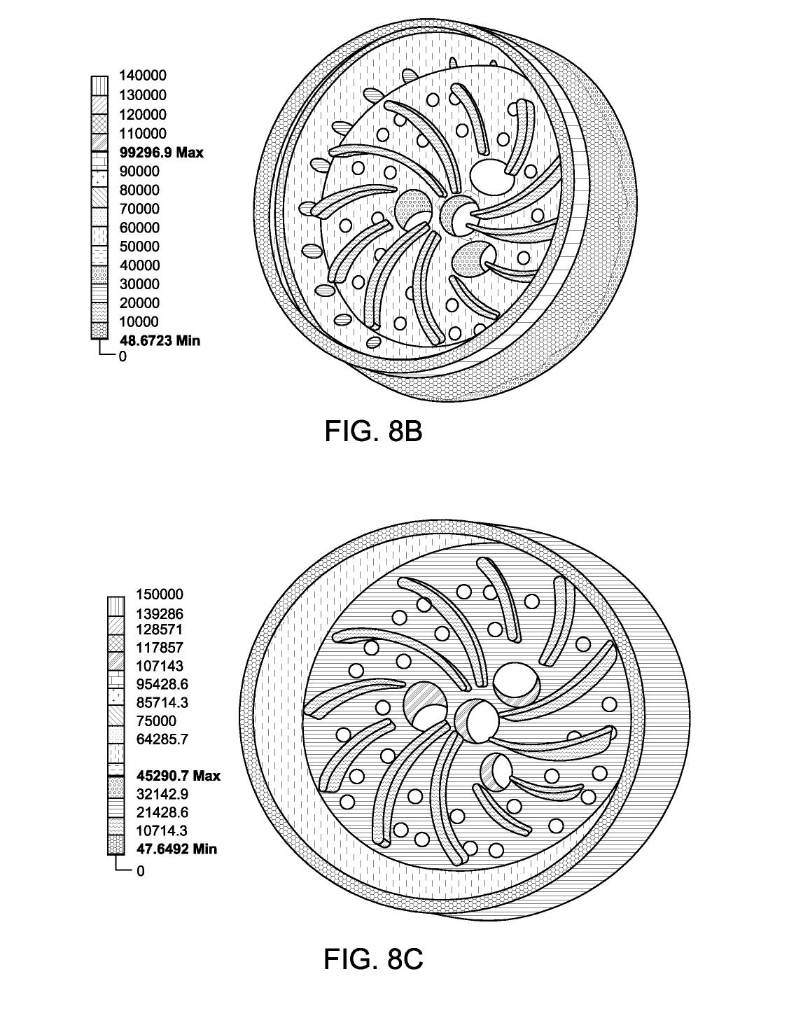

FIGS. 8A-C shows stress profiles obtained for various nozzle tips described herein. FIGS. 8A-C show stress profiles of the nozzle tips of FIGS. 7A-C, respectively. A maximum stress of the nozzle tip of FIG. 8A is 134 kilopounds per square inch (KSI). The maximum stress of the nozzle tip of FIG. 8B is 99.3 KSI. The maximum stress of the nozzle tip of FIG. 8C is 45.3 KSI. Therefore, the stress profiles of FIG. 8 show the effect of the features disclosed herein on reducing stress at the nozzle tip. The reduced stress contributes to extending a lifespan of the nozzle tip.

Therefore in one aspect, the present disclosure provides a nozzle tip that includes a face, at least one passage at the face configured to enable a gas impinging on the face to flow through the nozzle tip, and at least one rib extending from the face configured to transfer heat from the nozzle tip to the impinging gas. The at least one rib extending from the face provides a surface area of the face that is greater than the surface area of a planar face of the nozzle tip. In various embodiments, the at least one rib is formed along one of: (i) a radial line of the nozzle tip, and (ii) a spiral emanating from a substantial center of the nozzle tip. In another embodiment, a radially central end of the at least one rib extends from the face to a distance that is less than or equal to a distance that a radially distal end of the at least one rib extends from the face. In an embodiment in which the at least one passage includes a plurality of ribs, the at least one passage can include one or more passages formed on the face between the plurality of ribs. The at least one passage can also or alternatively include one or more passages formed on an extended face of the at least one rib. In various embodiments, a cross-sectional area of the at least one passage varies with depth. The gas flowing through the nozzle tip can be at least one of air and an air/fuel mixture.

In another aspect, the present disclosure provides a combustion burner, including a nozzle for dispensing a gas for combustion; and a nozzle tip coupled to an end of the nozzle, wherein the nozzle tip includes a face configured to be directed toward the nozzle when the nozzle tip is coupled to the nozzle, at least one passage at the face configured to enable the gas from the nozzle to flow through the nozzle tip, and at least one rib extending from the face configured to transfer heat from the nozzle tip to the gas. The at least one rib extending from the face of the nozzle tip provides a surface area of the face that is greater than the surface area of a planar face of the nozzle tip. In various embodiments, the at least one rib can be formed along one of: (i) a radial line of the nozzle tip, and (ii) a spiral emanating from a substantial center of the nozzle tip. In one embodiment, a radially central end of the at least one rib extends from the face to a distance that is less than or equal to a distance that a radially distal end of the at least one rib extends from the face. In an embodiment in which the at least one rib includes a plurality of ribs, the at least one passage can further include one or more passages formed on the face between the plurality of ribs. The at least one passage can include one or more passages formed on an extended face of the at least one rib. In various embodiment, a cross-sectional area of the at least one passage varies with depth. The gas flowing through the nozzle tip can be air and/or an air/fuel mixture.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A nozzle tip, comprising:
a face;
at least one passage at the face configured to enable a gas impinging on the face to flow through the nozzle tip; and
at least one rib extending from the face configured to transfer heat from the nozzle tip to the impinging gas.

2. The nozzle tip of claim 1, wherein the at least one rib extending from the face provides a surface area of the face that is greater than the surface area of a planar face of the nozzle tip.

3. The nozzle tip of claim 2, wherein the at least one rib is formed along one of: (i) a radial line of the nozzle tip, and (ii) a spiral emanating from a substantial center of the nozzle tip.

4. The nozzle tip of claim 3, wherein a radially central end of the at least one rib extends from the face to a distance that is less than or equal to a distance that a radially distal end of the at least one rib extends from the face.

5. The nozzle tip of claim 1, wherein the at least one rib further comprises a plurality of ribs and the at least one passage further comprises one or more passages formed on the face between the plurality of ribs.

6. The nozzle tip of claim 1 further comprising one or more passages formed on an extended face of the at least one rib.

7. The nozzle tip of claim 1, wherein a cross-sectional area of the at least one passage varies with depth.

8. The nozzle tip of claim 1, wherein the gas is at least one gas selected from the group consisting of: (i) air; and (ii) an air/fuel mixture.

9. A combustion burner, comprising:
a nozzle for dispensing a gas for combustion; and
a nozzle tip coupled to an end of the nozzle having:
a face configured to be directed toward the nozzle when the nozzle tip is coupled to the nozzle,
at least one passage at the face configured to enable the gas from the nozzle to flow through the nozzle tip, and
at least one rib extending from the face configured to transfer heat from the nozzle tip to the gas.

10. The combustion burner of claim 9, wherein the at least one rib extending from the face of the nozzle tip provides a surface area of the face that is greater than the surface area of a planar face of the nozzle tip.

11. The combustion burner of claim 10, wherein the at least one rib is formed along one of: (i) a radial line of the nozzle tip, and (ii) a spiral emanating from a substantial center of the nozzle tip.

12. The combustion burner of claim 11, wherein a radially central end of the at least one rib extends from the face to a distance that is less than or equal to a distance that a radially distal end of the at least one rib extends from the face.

13. The combustion burner of claim 9, wherein the at least one rib further comprises a plurality of ribs and the at least one passage further comprises one or more passages formed on the face between the plurality of ribs.

14. The combustion burner of claim 9 further comprising one or more passages formed on an extended face of the at least one rib.

15. The combustion burner of claim 9, wherein a cross-sectional area of the at least one passage varies with depth.

16. The combustion burner of claim 9, wherein the gas is at least one gas selected from the group consisting of: (i) air; and (ii) an air/fuel mixture.
